(19) United States
(12) Patent Application Publication
(10) Pub. No.: US 2026/0087266 A1
(43) Pub. Date: Mar. 26, 2026

(54) USING AUTONOMOUS AI AGENTS TO PERFORM COMPLICATED TASKS IN FUSION CLOUD APPLICATIONS

(71) Applicant: Oracle International Corporation, Redwood Shores, CA (US)

(72) Inventors: Arun Kutty, Amsterdam (NL); Ranveer Tiwari, Karnataka (IN); Liviu Matei, Bucharest (RO)

(73) Assignee: Oracle International Corporation, Redwood Shores, CA (US)

(21) Appl. No.: 18/898,383

(22) Filed: Sep. 26, 2024

Related U.S. Application Data
(60) Provisional application No. 63/688,378, filed on Aug. 29, 2024.

(30) Foreign Application Priority Data
Sep. 26, 2024 (RO) A 2024 00576

(51) Int. Cl. G06F 40/40; G06F 16/28; G06F 40/279

(52) U.S. Cl. CPC G06F 40/40; G06F 16/285; G06F 40/279

(57) ABSTRACT

A method of processing user queries includes receiving a request with natural language components. A logical dependency is determined between a first natural language component and a second natural language component and categories are determined for each of the natural language components. Based on the determined categories, selecting candidate natural language processing services for processing each of the natural language components. Sending the first natural language component to the first natural language processor, receiving a response, and sending the response and the second natural language component to the second natural language processing service. A response from the second natural language processing service is received which includes an option to trigger one or more actions in an application.

### CROSS REFERENCE OF RELATED APPLICATIONS

This application claims priority to U.S. Provisional Patent Application No. 63/688,378, filed on Aug. 29, 2024, titled “Using Autonomous AI Agents to Perform Complicated Tasks in Fusion Cloud Applications”, and to Romanian Patent Application No. A2024-00576 filed Sep. 26, 2024, titled “Using Autonomous AI Agents to Perform Complicated Tasks in Fusion Cloud Applications”, both of which are incorporated by reference in their entireties for all purposes.

### BACKGROUND

An enterprise data ecosystem involves data of multiple different applications all used by an organization for managing organization systems. Enterprise data ecosystems can create a challenge for users attempting to modify data of the enterprise data ecosystem as there may be multiple applications within the ecosystem that manage different groupings of data. Users may have an idea of what actions they want to be performed, but may not be able to implement those actions within the ecosystem without total knowledge of all of the applications and how to use them. Even with such knowledge, such tasks may be time-consuming, inefficient, and difficult to accomplish.

For tasks that can be done in a single application, once the user finds the right application for a task, the user may communicate with the application using natural language requests such as within a chatbot. The natural language requests are bound by the capabilities of the application and the possible use cases configured for that application. The application cannot determine how the data will be used once the user navigates away from the application to work on other tasks.

### BRIEF SUMMARY

In some embodiments, a computer-implemented method includes receiving a request with natural language components. A logical dependency is determined between a first natural language component and a second natural language component and categories are determined for each of the natural language components. Based on the determined categories, selecting candidate natural language processing services for processing each of the natural language components. Sending the first natural language component to the first natural language processor, receiving a response, and sending the response and the second natural language component to the second natural language processing service. A response from the second natural language processing service is received which includes an option to trigger one or more actions in an application.

In some embodiments, a method includes receiving a request including a natural language item, the natural language item including a first natural language component and a second natural language component, determining a logical dependency of the second natural language component on the first natural language component, determining a first category for the first natural language component, determining a second category for the second natural language component, selecting, from a plurality of different candidate natural language processing services, a first natural language processing service associated with the first category and which supports one or more first applications, selecting, from a plurality of different candidate natural language processing services, a second natural language processing service associated with the second category and which supports one or more second applications, sending the first natural language component to the first natural language processing service, receiving a first response from the first natural language processing service including one or more values responsive to the first natural language component, based at least in part on the second natural language component and the one or more values responsive to the first natural language component, generating a modified second natural language component, sending the modified second natural language component to the second natural language processing service, receiving a second response from the second natural language processing service including an option to trigger one or more actions in at least one second application of the one or more second applications responsive to the modified second natural language component, triggering the one or more actions by sending one or more commands to the at least one second application.

In an alternative embodiment, a method also includes causing the display to a user the option to trigger the one or more actions in the at least one second application, and the triggering the one or more actions is in response to receiving a confirmation from the user.

In an alternative embodiment, a method also includes accessing metadata that describes one or more candidate operations for the one or more first applications, generating a prompt including at least part of the metadata and the first response, and prompting a large language model with the prompt to validate that the first response is a valid response for the first category.

In an alternative embodiment, a method also includes prompting a large language model with the natural language item to detect the first natural language component and the second natural language component from the natural language item, and receiving the first natural language component and the second natural language component from the large language model.

In an alternative embodiment, a method also includes accessing one or more stored rules to detect separation between natural language components and determining the first natural language component and the second natural language component from the natural language item based at least in part on a particular detected separation between the first natural language component and the second natural language component.

In an alternative embodiment, determining the first category for the first natural language component includes generating a prompt including the first natural language component and a plurality of candidate categories, prompting a large language model with the prompt to determine a particular category of the plurality of candidate categories for the first natural language component, and based at least in part on a result of the prompting, determining the first category for the first natural language component.

In an alternative embodiment, the first natural language processing service may include a first machine learning model, the first machine learning model may be trained based at least in part on first metadata that describes one or more first candidate operations for the one or more first applications, the second natural language processing service may include a second machine learning model, and the second machine learning model may be trained based at least in part on second metadata that describes one or more second candidate operations for the one or more second applications.

In an alternative embodiment, a method also includes generating a prompt including the one or more commands, prompting a large language model to generate a natural language description of the one or more commands, and determining the one or more actions based at least in part on a response from the prompting.

In an alternative embodiment, a method also includes causing display of the one or more actions to a user, receiving an input from the user indicating against the one or more actions, and to reverse the one or more actions, sending to the at least one second application another one or more commands associated with the one or more commands.

In an alternative embodiment, the one or more actions may partially accomplish the request defined by the natural language item, the particular interface includes one or more options to complete the request defined by the natural language item, and a method also includes causing navigation to a particular interface in the at least one second application.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart of an example process for processing user queries.

FIG. 2 illustrates a flow chart of an example process for processing user queries with multiple component tasks.

FIG. 3 illustrates a system diagram showing an example distributed system for implementing a user query processing system.

FIG. 4 illustrates a diagram of an example user interface for receiving user queries.

FIG. 5 depicts a simplified diagram of a distributed system for implementing certain aspects.

FIG. 6 is a simplified block diagram of one or more components of a system environment by which services provided by one or more components of an embodiment system may be offered as cloud services, in accordance with certain aspects.

FIG. 7 illustrates an example computer system that may be used to implement certain aspects.

### DETAILED DESCRIPTION

A method of processing user queries involves determining a first and second natural language component of a user query, and determining categories for each of the components. Based on the determined categories, candidate natural language processing services are selected for processing each of the components. The first natural language component is sent to the first natural language processor, a response is received, and the response and the second natural language component are sent to the second natural language processing service. A response from the second natural language processing service is received which includes an option to trigger one or more actions in an application.

In various embodiments, the processing of user queries is implemented using non-transitory computer-readable storage media to store instructions which, when executed by one or more processors of a computer system, cause display of the user interface and processing of the received input to process user queries. The processing of user queries may be implemented on a local or cloud-based computer system that includes processors and a display for showing the user interface to a user for processing user queries. The computer system may communicate with client computer systems for processing user queries.

A description of processing user queries is provided in the following sections:
GENERAL OVERVIEW
TASK AND AGENT DETERMINATION
AGENT PERFORMANCE OF TASKS.
CREATION OF NEW AGENTS
MULTIPLE TASK QUERY PROCESSING
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### General Overview

Enterprise data ecosystems often include a variety of tools and applications for interacting with enterprise data and the external systems connected to the ecosystem. Each tool or application may have different functions within the enterprise data ecosystem, such as providing reports from the data, editing the data, executing jobs depending on the data, or changing configurations within the data ecosystem. Each of these functionalities may be provided by different tools with different user interfaces. Applications may be interacted with to cause the execution of certain functions within the application by another application via the application's application programming interface (API), however, programming functions within a first application to interact with a second application via the second application's API requires a considerable amount of effort to configure and continually maintain.

A user query processing service handles incoming user queries from various users within the enterprise data ecosystem. The user query processing service may provide a common user interface for users to use in submitting queries that include any combination of tasks to perform within the enterprise data ecosystem. The user interface may be run on the same device that performs processing of the user queries, or the user interface may be displayed on a user device that connects to a remote device, such as a server, for processing the user queries that the user device is connected to in a session with an application run on the remote device.

A server for processing user queries that is part of the user query processing service may establish connections with user devices that connect to it in an application session of the server for managing user queries. The server may receive a user query, process the user query, generate an execution plan for addressing the user query, and return a response to the user query to the user device within the same or a different application session. The server may maintain the same application session for responding to multiple user queries from a single user such that information of previous queries may be utilized in responding to further related queries from the user.

The user interface may accept natural language queries from the user that are interpreted by the user query processing service to determine the required tasks to complete to fulfil the user query. The user query processing service may determine tasks to execute included within a natural language query and determine a method of executing those tasks. The user query processing service may first detect tasks to execute included within a natural language query. Each query or task may be determined by the user query processing service to relate to a specific category or domain in order to further aid in executing the required tasks.

The user query processing service may contain one or more agents capable of performing certain tasks within the enterprise data ecosystem. The one or more agents may be category or domain specific, such that they are specialized in handling a set of tasks of the category or domain to which they relate. Category or domain specific agents may be created and optimized separately by users that are subject matter experts for the given category or domain and thus can best optimize the relevant agent. The user query processing service may determine an agent to use in performing certain tasks based on a category or domain determined for that task. By the creation and use of various agents for handling myriad tasks across an enterprise data ecosystem, the user query processing service can act as a single interface for interacting with an enterprise data ecosystem without requiring a substantial technical overhead to create individual function calls between applications.

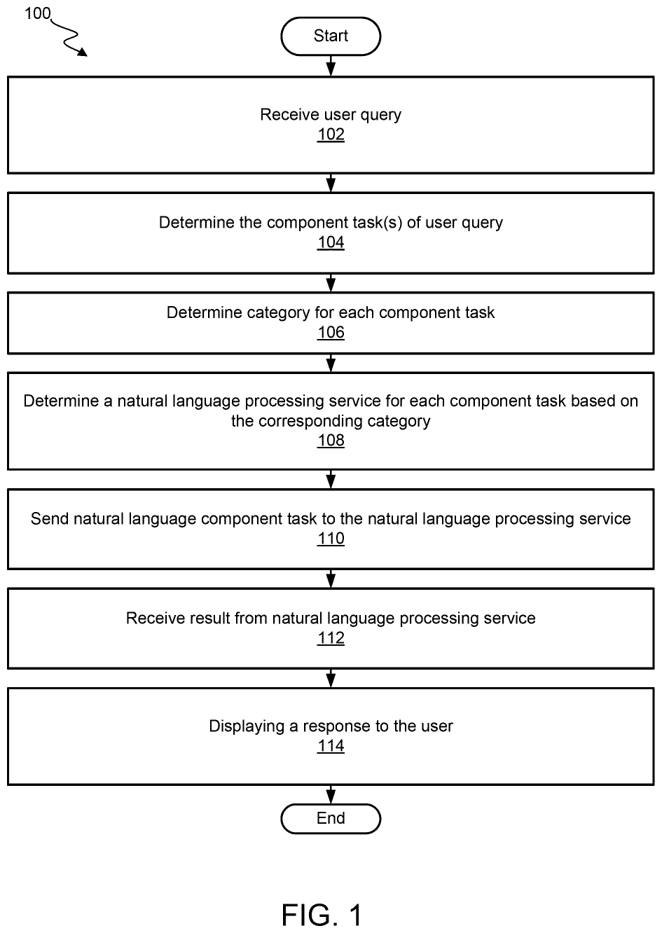

FIG. 1 depicts a flowchart of a process 100 for processing user queries. At block 102, a user query is received from a user. The user query may include a natural language component. At block 104, the system determines the component task or tasks of the user query. The tasks may be determined to be one of the natural language components of the user query. At block 106, the system determines a category for each component task of the user query that were determined in block 104. The category may be determined by analysis of the natural language of the task. At block 108, a natural language processing service is determined for each component task, that will perform the component task, based on the corresponding category of the component task. At block 110, the natural language component task is sent to the determined natural language processing service for that task. The natural language processing service determines the actions required to perform the component task and executes those actions. At block 112, a result is received from the natural language processing service. The result may be a part of the performance of the component task or may be a confirmation of performance of the component task. At block 114, a response is displayed to the user based at least in part on the result from the natural language processing service.

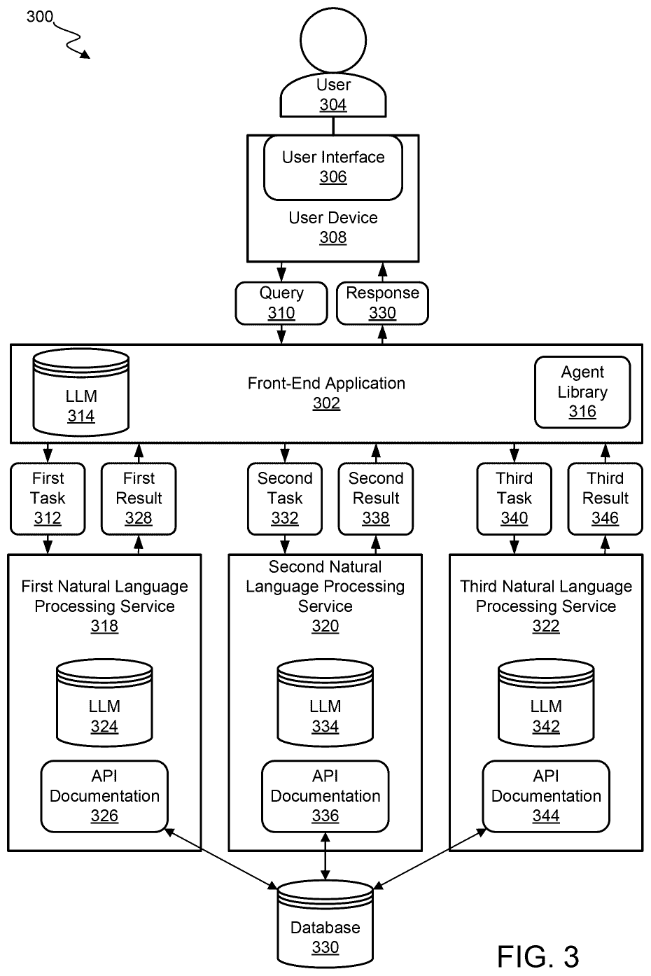

FIG. 3 depicts a distributed system 300 for implementing a user query processing service for an enterprise data ecosystem. The distributed system 300 includes a front-end application 302 accessed by a user 304 via a user interface 306 displayed on a user device 308. The user 304 enters a query 310 including at least one task 312 in a natural language format into the user interface 306. The front-end application 302 receives the query 310 from the user device 308. The front-end application contains a first natural language processing service 314 for interpreting natural language components of user queries. The first natural language processing service 314 parses the query 310, such as by passing to a first large language model 316, and detects the at least one task 312. The natural language processing service 314 determines a category for the at least one task 312. The front-end application 314 includes an agent library 318 that records information to a plurality of agents 320-324. The front-end application 314 references the agent library 318 and determines a first agent 320 of the plurality of agents 320-324 corresponds to the category of the at least one task 312. The at least one task 312 is transmitted to the first agent 320. The at least one task 312 is interpreted by the first agent 320, such as by using a second large language model 326. The first agent 320 accesses the relevant database 328 to perform actions required by the at least one task 312. The first agent 320 returns a first result 330 to the front-end application 314. The front-end application 314 generates a response 332, at least in part based on the first result 330, and causes the display of the response 332 on the user interface 306 on the user device 308.

The user query processing service may determine a query to include multiple tasks. Each task of the multiple tasks detected by the user query processing service may be of a different category or domain and thus may be executed by a different agent within the user query processing service. The tasks of the multiple tasks may have a relationship that requires the prior execution of another task of the multiple tasks first. The user query processing service may manage the agents in performance of the multiple tasks such that the tasks are performed in order as required by the relationship between tasks and to optimize performance of the tasks by the agents.

### Task and Agent Determiniation

Determination of a Task within a Query

A user query may include an intended task to be performed by the user query processing service. The user query processing service may detect the task to be performed from the user query via parsing the user query in a rule-based task detection method or by passing the user query to a large language model trained to detect tasks within the user query. A task within a user query may be determined to be a component within the user query that designates or implies an action to be performed within the enterprise data ecosystem by an agent.

A user query may include multiple components, including multiple tasks. A user query may include other components that are not part of a specific task and the user query processing service may determine the components of a query that are part of the specific task and which parts of the query are not part of the specific task. For example, a natural language user query may include an introductory phrase such as “Hello AI” or “Please” before a task written in natural language: “Hello AI, please pull all records of sales to customer ID 12345.” Such extraneous components that are not part of the specific task may be removed and the task stored as the remainder of the user query. Alternatively, extraneous components may be included in passing the user query to a large language model for task detection if such components provide context to the user query. Extraneous components that provide context to a query that may assist in task detection may include punctuation or grammatical components that delineate separate ideas within a sentence such as conjunctions. In the case that a query includes multiple tasks, the multiple tasks may be detected by the delineation of the multiple tasks by extraneous components such as detecting two tasks that are separated by a conjunction.

### Rule-Based Agent Determination

The user query processing service may determine an agent for performing detected tasks within a query via a set of pre-determined rules. The pre-determined rules may include keywords that, when detected in a query, correlate with a specific agent to use for performing the task of which that keyword is a part. For example, a stored library of keywords may contain a relationship between the keyword “employee” and an agent for handling talent management. By detecting the word “employees” within the query “find all employees with birth dates in August” the user query processing service determines that the talent management agent is the proper agent for handling the task. The relationship to an agent may be dependent upon the presence of multiple keywords within the query. For example, for the above example query, a pre-defined relationship may relate the talent management agent to the presence of the word “employee” and at least one of the words “ID,” “birth date,” or “SSN.” As the terms “employee” and “birth date” are present within the query, the system may determine based on the pre-defined rule that the talent management agent is the proper agent for handling the task. A keyword library for implementing a keyword based agent determination may include multiple variations of the same term or meaning. For example, the keyword library may store “birth date,” “date of birth,” or “DoB” as being identical for the purposes of checking rules for determining an agent to use.

One rule for determining agents for performing tasks may specify language or markers a user may enter in the query or within the user interface for pre-determining the category or domain for the relevant task. In one example, the user may enter a query in natural language format that recites: “Find the client with the most orders from October [Sales].” The user query processing service may have a pre-defined rule for determining an agent based on a marker within the query within square braces. The user query processing service, when parsing the user query, detects the word “Sales” within square braces and, according to the pre-defined rule, compares the word “Sales” to the set of categories or domains to select the corresponding category or domain for the task within the user query. In another example, the user may enter a natural language request in the user interface and the user interface may display to the user in a second user interface the detected task from the user query with a prompt to determine the category or domain for the task. The prompt to determine the category or domain may receive natural language text or prompt the user to select from the list of categories or domains. The category or domain indicated by the user on the second user interface is then used as the category or domain for the given task.

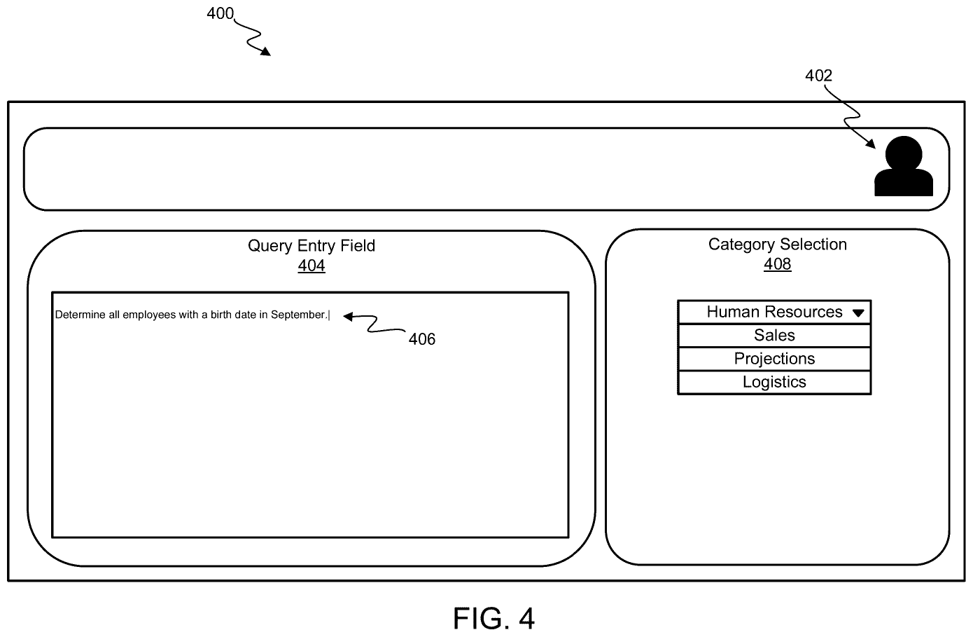

FIG. 4 depicts a user interface 400 for receiving a user query. A user 402 uses the user interface which may validate a connection for an application session for the user based on user credentials of the user 402. The user interface 400 includes a query entry field 404 for receiving a user query 406. The user query 406 is entered by the user 402 in a natural language format. The user interface may also include a category selection 408 for the user 402 to select a category to describe the task of their query. The user query processing service may then use the category selected in the category selection 408 as the category for the task of the user query 406.

### LLM Agent Determination

The user query processing service may determine an agent for performing detected tasks within a query via passing the query or a component of the query to a large language model trained to detect tasks within a query and determine an agent for performing that task. The large language model may be a large language model used for other types of prompts or it may be specifically trained and used for task detection and agent determination. The user query processing service may utilize two prompts to large language models in agent determination: a first prompt to determine a task or tasks within the user query, and a second prompt to determine an agent for performance of a task determined as a result of the first prompt. The two prompts may be submitted to the same or different large language models.

Each possible agent to use for performing a task may be recorded in an agent catalogue. The agent catalogue may also include metadata describing the category or domain that each agent is associated with. The agent catalogue may be accessible by the large language model used to determine the agent for a given task or it may be provided within the prompt to the large language model for determining the agent for a given task.

The user query processing service may alternatively determine an agent for performing detected tasks within a query via a text vector embeddings similarity. The user query processing service may determine vector embeddings of the task and the vector embeddings of the documentation of the API of possible domains. The user query processing service may then determine a closest domain via a vector similarity search between the vector embeddings. As each agent is associated with a specific domain, the determination of the closest domain may be used to determine the corresponding agent of that domain as the agent to use in performing the specific task.

Alternatively, the determination of an agent to use for performing a specific task may be performed using a combination of methods. A vector similarity search may be performed between the vector embeddings of the user query and the vector embeddings of the documentation of the API of possible domains to determine a set of closest domains. The set of closest domains may then be passed to a large language model with the specific task to determine a best domain to use of the set of closest domains.

In another embodiment, the user query may be parsed to detect key words from the documentation of APIs of various domains. For each detected key word from an API documentation, the related domain may be recorded as a potential domain in a set of potential domains. After parsing the user query, the set of potential domains and the user query may be passed to a large language model to determine a closest domain to the user query and thus a best agent to use in performing the specific task of the user query.

### Agent Performance of Tasks

When an agent is designated for performance of a component task, the user query processing system sends the component task to the agent. The agent may process the task to determine a set of action to perform and performs those actions to satisfy the task performance. The agent may be specific to a given data domain within the enterprise data ecosystem. By utilizing agents specific to a given data domain that matches the determined domain for a given task, the agent may better satisfy the task performance.

Agents may be specific to categories, which may generally map onto individual applications within an enterprise data ecosystem. For example, categories an agent may be specific to may include human capital management (HCM), sales, logistics, or other sectors of an organization. By designating an agent specific to one of these categories, that agent may be trained on tasks involving the data specific to that category or applications specific to that category. As the number of applications specific to a given category may be few, the agent specific to that given category is trained narrowly and may be more accurate for those applications.

Agents may also be specific to data domains, which may be more specific than categories of data or tasks. For example, a user query processing system may include an HCM integration agent, an HCM reporting agent, an HCM fast formula agent, an HCM workflow agent, an HCM payroll flow agent, an HCM extracts agent, or an HCM configuration agent. Each of these agents, specific to one domain, may be trained on a limited number of tasks or actions performed for their given data domain.

The agent may include a large language model trained at least on metadata of the domain specific to the agent. In order to determine the set of actions to perform to satisfy the task performance, the agent may prompt the large language model to determine the set of actions to perform. The agent first generates a prompt including at least a portion of the task. The prompt may also include metadata of the data domain specific to the agent, examples of task language and corresponding actions to perform for that task language, or rules for constraining the determination of the actions to perform. The prompt also includes a request to generate the actions in the form of commands executable on the database. For example, the prompt may prompt a large language model to determine the proper API function calls with included arguments to perform as actions to satisfy the task performance.

The large language model may also be implemented as part of retrieval-augmented generation to determine the actions to perform. In this embodiment, vector embeddings of the task are generated and used to query a vector database of the vector embeddings of metadata of the domain specific to the agent. The vector database query retrieves information relevant to the task such as information from API documentation such as API function calls that are relevant to the task. Similarity between the query and the task may be determined based on a distance or similarity analysis. The agent may then construct a prompt including the retrieved relevant metadata and the task. When generating the actions, the large language model may then be constrained to generate the commands from the API function calls provided in the prompt, which are the most likely API function calls for properly satisfying task performance.

The distance or similarity analysis may be performed on a whole vector embedding of queries and/or task data or by breaking up vectors into components to determine correlation of corresponding components across the vectors. Columns may be counted as correlated if the correlation measure exceeds the correlation threshold. In an alternative embodiment, the columns may be compared to determine correlation clusters, where columns are determined to be part of a cluster if the correlation between all combinations of columns in the cluster is above a certain threshold.

A Pearson Correlation Coefficient between two vectors is calculated as a ratio between the covariance between the vectors and the product of the standard deviations between the two vectors. A correlation coefficient of 1 represents identical vectors, a correlation coefficient of −1 represents opposite vectors, and a correlation coefficient of 0 represents vectors that are not correlated.

A Cosine Distance or cosine similarity between two vectors is determined by calculating a cosine of the angle between the two vectors. A result of 1 represents a cosine similarity between two identical, a result of −1 represents a cosine similarity between two opposite vectors, and a result of 0 represents a cosine similarity between two unrelated or orthogonal vectors.

A Euclidean Distance is determined by calculating a square root of a sum of the squares of the distances between components of the two vectors. The higher the Euclidean distance, the lower the similarity between the components of the vectors used in the calculation.

A Manhattan Distance is calculated as a sum of the absolute differences between components of the vectors. The higher the Manhattan Distance, the lower the similarity between the components of the vectors used in the calculation.

A Minkowski Distance is calculated as the p-th root of the sum of the absolute differences between components of the vectors raised to a power, p, for each component pair. The Minkowski Distance equals the Manhattan Distance when p=1 and the Euclidean Distance when p=2. The higher the Minkowski Distance, the lower the similarity between the components of the vectors used in the calculation.

A Hamming Distance between two vectors is determined based on how many positions at which corresponding components of the vectors are different or sufficiently different. For each component pair in the vectors that are different, a counter is incremented. The Hamming Distance is the total counter for the vectors across all component pairs.

A Chebyshev Distance between two vectors is calculated as the greatest of the absolute differences among the vectors' corresponding components. The largest absolute difference among all the pairs of components is the Chebyshev Distance. The larger the Chebyshev Distance, the lower the similarity between the vectors.

A Jaccard Distance between two vectors is calculated as a ratio between the size of the intersection between the vectors (based on elements in common between the vectors) to the size of the union between the vectors (based on elements in either or both of the vectors). Jaccard Similarity is defined by the ratio, and Jaccard Distance is defined as one minus the Jaccard Similarity.

The Sørensen-Dice Similarity is calculated as two times the number of elements in common among the vectors divided by the sum of the number of elements in each vector. The Sørensen-Dice Distance is one minus the Sørensen-Dice Similarity.

The prompt to the large language model may also include rules constraining the determination or execution of actions for the satisfaction of task performance. The rules may enforce data access restrictions by defining data structures that may be accessed or that the agent is prohibited from accessing. Data access restrictions may be defined by database access restrictions relating to a user's access credentials. The agent may access the user's access credentials and establish a database session with the database to request the database access restrictions for the user's access credentials. In this embodiment, the agent may determine whether any actions performed by the agent will be able to satisfy task performance. For example, a task may request the altering of a data value in a database. The agent may access the user's credentials and establish a session with the database. The agent then determines if there are any access constraints based on the user's credentials such as a restriction on altering data within the database. If the agent determines that the user is restricted from altering data within the database, the agent may return a result that the task may not be completed as requested in the user query.

A rule constraining determination or execution of actions for the satisfaction of task performance may also include pre-determined relationships between API or function calls. For example, a specific API function call to access data within an application may require a first API call to establish data access credentials for the application. A pre-determined rule for the data access API function call may state that for any action using the API function call a prior action must be performed to use the data access credential API call.

The prompt to the large language model may also include examples of inputs and outputs for generating the actions for satisfying task performance. The agent may access stored example tasks with corresponding executable commands that satisfy those examples tasks. The agent may store example tasks specific to the domain of the agent, such as example tasks from past tasks completed by the agent and the commands generated and executed by the agent for those past tasks. The stored example tasks may be determined by a process of user feedback. The example tasks may also be stored within metadata of the domain specific to the agent. For example, an API documentation may include example function calls and tasks satisfied by those function calls.

After determining the actions to perform for performance of the component task, the agent may executes those actions against a database to perform the component task or may return the executable instructions of the actions as a result to the front-end application to execute the actions. The agent may establish a new session with the relevant database and executes the executable instructions in the database session. Alternatively, the agent may return a result of the executable instructions of the actions to perform which, upon receipt, the front-end application establishes or uses a database session and executes the executable instructions. The front-end application may also cause the display to a user interface for the user the option to trigger the actions. Upon receiving a confirmation in the user interface of the execution of the actions, the front-end application executes the executable instructions to perform the actions.

An example task execution by an agent may be conducted as follows. A Human Capital Management (HCM) integration agent receives a task to identify a person's date of birth. The HCM agent identifies the user who entered the query, and determines data related to the user's data access. The HCM agent identifies the data object and query fields for the data request, in this case the date of birth is a selected field, therefore the HCM agent may conclude that the data object will be a person and a data column of the data object would be the date of birth. The HCM agent identifies the identifying data within the task language. The HCM agent constructs a SQL SELECT clause accessing the date of birth column of the person object with a WHERE clause specifying the identifying data. The HCM agent checks an API documentation file to determine an API function call that, when the user's data access data is applied, will return the right end point. The HCM agent builds the right end point with the constructed SQL payload. Finally the HCM agent executes the end point.

The front-end application may prompt the user to confirm the execution of any actions within the pipeline of component tasks. When confirmation of intermediate steps of a pipeline may be recorded as positive feedback for the category, agent, task, or action determination by the system. Alternatively, whether to automatically execute the actions of a component function may be determined by the component function's position within the pipeline. For example, a pipeline with three tasks may set a setting for the agents performing the first and second component tasks to automatically execute their respective actions while a setting for the third agent determines that the third agent should return a result of the executable instructions for its corresponding actions to be executed by the front-end application upon confirmation of an option to trigger the actions by a user in a user interface.

In the case of automatic execution of actions for a component task, a result may be returned detailing the actions performed by the agent. The front-end application may cause the display of the actions performed by the agent in a user interface for the user. The user interface may permit input from the user to indicate feedback for the actions performed. In the case that the user indicates against the actions performed, the front-end application or the agent may determine executable instructions, based on the executable instructions of the actions, to perform to reverse the actions performed.

The executable instructions returned by the agent may be specific to a particular interface of an application. The front-end application, upon receipt of the executable instructions specific to a particular interface of an application, may cause the navigation to the particular interface by the user's device and execute the executable instructions via the particular interface on the user's device. The executable instructions may partially accomplish the request defined by the component task, however, it may require an input in the particular interface to fully complete the request. The particular interface may comprise one or more options to complete the request, such as a confirmation button, along with the display of the result of the executable instructions' partial accomplishment of the request or a display of the actions performed for partial accomplishment of the request.

### Validation and Feedback

After performance of a task, the result of the task may be validated. The result may be validated automatically or by a process of user feedback. The result may be validated for the proper determination of categories or domains or the result may be validated for the proper determination and performance of actions for satisfying task performance.

After performance of the task, the agent may validate the performance of the task. The agent may have pre-set actions for validating certain actions or API calls within its given domain. For example, if an agent modified data in the performance of a task, the agent may record the actions performed and after performance detect a data modification API call was used. The agent may then compare the API call action to determine that a corresponding data value check should be performed to validate the performance of the task and perform that data value check by a corresponding API call.

In another embodiment, the agent may prompt its large language model, trained on the specific domain of the agent, with the result and the task to determine if the task was performed properly. The prompt may further indicate to return a suggested action to perform in the case that the task was performed incorrectly.

Alternatively, the validation may be performed by the front-end application upon receipt of the result of the task. After receiving the result of performance of a task by an agent, the front-end application may automatically validate the result. The front-end application may validate the result by prompting a large language model with the result and the determined category for the given task. The large language model may be the same large language model used to determine the category for the task before performance of the task by the agent. The large language model may be prompted to determine whether the result is a valid result for the given category.

Alternatively, the front-end application may validate the result of the task via a query to the user. The front-end application may send the result to the user's device to display in a human-readable format and prompt the user to confirm if the result is as expected. The prompt may specify for the user to respond whether the result is the correct action to perform within the domain or whether the result indicates that the incorrect category was determined for the task. In the case that the user responds that the result is not the correct action to perform, the front-end application may return the task to the agent determined for that task along with the previous action performed, the result, and an indication that the action did not achieve the proper result. The agent may then attempt to determine a new action to perform and may include the previous action as a negative example in prompting a large language model to determine the proper action to perform. In the case that the user indicates that the incorrect category was determined for the task, the front-end application may determine a new category for the task to determine a new agent to perform the task, including the previously determined category or domain as a negative example of an incorrect category determination.

In the case that a user indicates that a result was correct, the user query processing system may store the task, the actions performed, the determined category or domain, or the result as positive examples for future query processing. For example, in response to an indication that the proper actions were performed to satisfy at task, the agent for that task may store the task and the determined actions as positive examples to be included in prompts for future task performance.

### Creation of New Agents

New agents may be added to the set of possible agents. When a new application or API is registered with the enterprise data ecosystem, the API or application function calls are registered with the documentation of the API or application, used for understanding the API or application and their uses. When a new API or application is registered, one or more new agents may be created for handling tasks relating to the domain of the API or application. A new agent may be created and trained initially on the documentation of the API or application, using the documentation as examples or labeled data for training the agents. A user may also define example tasks that may be requested that would utilize the API or application and the proper API or application function calls that would be used to satisfy performance of that task. Such examples may also be used as examples or labeled data for training the agent.

### Multiple Task Query Processing

When receiving a user query, the user query processing service may decompose the query into separate components that make up the query. The query may include multiple component tasks that are required to be performed to satisfy the whole query. For example, a query may request: “Set contract renewal flag to Yes for all persons in legal employer—US”

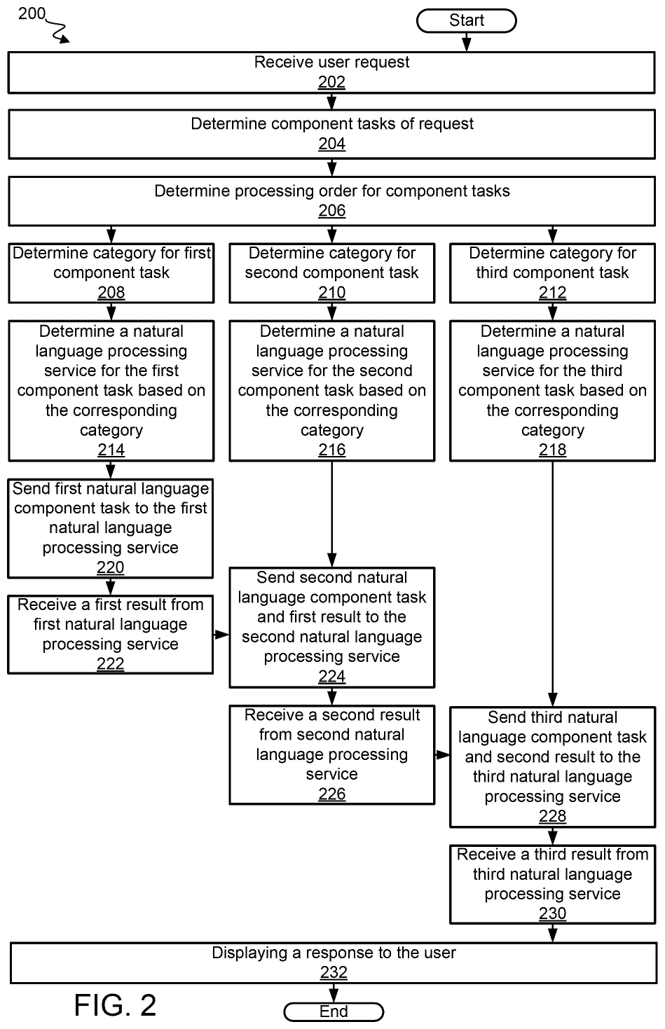

FIG. 2 depicts a flowchart of a process 200 for processing user queries with multiple tasks. At block 202, a user query is received from a user, this query may contain any number of component tasks within the query. At block 204 the user query is analyzed to determine a plurality of component tasks of the user query. As any component task of the user query may have a dependency on another component task in order to process the task, at block 206, a processing order is determined for the component tasks based on dependencies between the component tasks. Within this example, a first component task has been determined to be processed first, followed by a second component task, followed by a third component task as the second task depends on a result from the first task and the third component task depends on a result from the second task. At blocks 208-212, a category is determined for each component task to aid in processing the task. Blocks 208-212 may not depend on each other and the categories determined for each component task may be different or the same. Based on the determined categories, at blocks 214-218, a natural language processing service is determined for each of the component tasks. Blocks 214-218 may not depend on each other and the natural language processing service determined for each component task may be different or the same. As the first component task is performed first within the processing order, at block 220, the first natural language component task is sent to the first natural language processing service for processing. At block 222, a result is received from the first natural language processing service after processing the first task. At block 224, the second natural language component task is sent to the second natural language processing service along with the first result received at block 222. As the first result must first be received at block 222, the sending the first result is performed after block 222. Blocks 210, 216, or the sending of the second natural language component task may be performed before or concurrently with block 222. After processing the second natural language component task, at block 226, a second result is received from the second natural language processing service. At block 228, the third natural language component task is sent to the third natural language processing service along with the second result. As the second result must first be received at block 226, the sending the second result is performed after block 226. Blocks 212, 218, or the sending of the third natural language component task may be performed before or concurrently with block 226. At block 230, a third result is received from the third natural language processing service. At block 232, a response is displayed to the user, where the response is based at least in part on the third result.

Returning to FIG. 3, the user query may include three component tasks, 312, 332, and 340 as determined by the front-end application 302. After determining the three component tasks, 312, 332, and 340, a natural language processing service is designated for performing each of the component tasks. The second natural language processing service 320 is determined to perform the second component task 332. The third natural language processing service 322 is determined to perform the third component task 340. The component tasks 312, 332, and 340 may depend on each other such that the second component task 332 requires the first result 328 to be processed and the third component task 340 requires a second result 338 of the second component task 332 to be processed. The front-end application 302 determines an order for processing the component tasks 318-322 and first send the first component task 312 to be performed. The front-end application 302, after receiving the first result 328, sends the first result 328 to the second natural language processing service 320 along with the second component task 332. The second natural language processing service 320 processes the second component task 332 via the second large language model 334 to determine the actions required to perform the second component task 332. The actions required are performed in the database 330 via the second API documentation 336. The second natural language processing service 320 returns a second result 338 to the front-end application 302. The front-end application 302 then sends the second result 338 along with the third component task 340 to the third natural language processing service 322. The third natural language processing service 322 processes the third component task 340 via a third large language model 342 to determine a number of actions to perform the third component task 340. The third natural language processing service 322 performs the number of actions to perform the third component task 340 within the database 330 via the third API documentation 344. The third natural language processing service returns a third result 346 to the front-end application 302. The front-end application 302 generates and sends the response 330, at least based on the third result 346.

### Query Decomposition

The query may include multiple component tasks that must each be performed to satisfy the whole query. As the separate component tasks may correlate to different data domains, the component tasks may be performed separately such that the component tasks may be performed by specialized agents. In order to separately handle each component task by different agents, the user query must first be decomposed such that the component tasks are separated as individual tasks to perform. The user query processing service may decompose the query into component tasks by first detecting the bounds of each component task then storing the component tasks as separate tasks.

The user query processing service may detect the bounds of each component task by accessing one or more stored rules to detect separation between the component tasks. A stored rule may define that separate component tasks may be detected by detecting the presence of a particular separation element. For example, the rule may define that a set of words as possible separation elements, including conjunctions (e.g. “and,” “but”, “where”), prepositions, or adverbs. Alternatively, the rule may define a set of punction elements as possible separation elements, such as a semicolon.

Alternatively, the user query processing service may detect the bounds of each component task by prompting a large language model to determine the separate component tasks within a user query. The user query processing service may generate a prompt to a large language model including the user query and a request to the large language model to determine the separate tasks to be performed within the user query. The prompt may include metadata of the various data domains, such as examples of possible tasks for each domain. The prompt to the large language model may only request that that the component tasks be returned, or the prompt may request the large language model determine the component tasks and their categories or logical dependencies between the component tasks.

In yet another alternative, the user query processing service may detect the bounds of each component task by passing the query to a machine learning model trained to determine the separate component tasks within a query. The machine learning model may be trained with labeled data of queries and their component tasks pre-determined by users.

The component tasks may also be determined by a combination of the above methods. For example, a query may be parsed using a rule-based method to determine separation elements. A prompt may then be generated including the user query with the detected separation elements labeled and an added instruction informing that the labels of the separation elements implies a potential separation between component tasks. Alternatively, the user query with labeled separation elements may be passed to a machine learning model trained to detect component tasks from a user query.

### Task Pipeline Assembly

The performance of component tasks of a user query may depend upon the completion of prior component tasks within the same query. In order to properly satisfy performance of each component task and therefor satisfy the entire user query, the component tasks must be performed in an order such that each dependent component task may be performed with the necessary results of prior component tasks.

After a plurality of component tasks have been detected in a user query, a processing order or pipeline may be created to determine what order to perform the component tasks. A component task is generally performed after a prior component task of the same user query when it has a logical dependency on the prior component task. A logical dependency is a requirement of some data derived from the prior component task. For example, a second component task has a logical dependency on a first component task when the second component task requires an output value of the first component task in order to complete the second component task. In the user query “raise the salary of the highest producing employee” contains two component tasks: “raise the salary of X” and “determine X to be the highest producing employee.” The first component task, raising the employee salary, has a logical dependency on the outcome of the second component task's determination of the highest producing employee. Therefore, these two component tasks would be assembled in a pipeline such that the second component task, determine X to be the highest producing employee” will be performed before the first component task, “raise the salary of X.”

For all component tasks of all pipelines, some elements or actions of a component task may be performed concurrently or before actions of component tasks that are higher in the pipeline. For example, a user query of “change the address of user 1234 to the address of user 5678” includes two component tasks with at least two actions each. The first component task, “change the address of user 1234” comprises the first action of performing a lookup of the data associated with user 1234 and a second action of changing the address field for the user 1234 record. The second component task, “lookup the address of user 5678,” contains a third action of performing a lookup of the data associated with user 5678 and a fourth action of accessing the address field for the user 5678 record. The pipeline for these two component tasks may specify that the second component task is higher in the pipeline than the first component task. Whether specified by the pipeline or by determination of the system, the first action of the first component task, performing a lookup of the data associated with user 1234, may be performed at any point in the pipeline before the performance of the second action. For example, the first and third actions may be performed simultaneously by two separate agents, followed by the fourth action, whose result is used in the performance of the second action. In this way, the second component task is completed before the completion of the first component task such that the user query may be fulfilled, however, the actions within the component tasks may be performed in an efficient manner.

The pipeline may be determined by application of a rule-based method by applying pre-determined rules for determining a pipeline of component tasks. For example, a pre-defined rule may designate priority scores for actions of a pre-defined list of actions. In this example, actions such as modifications to values may have a lower priority than lookup actions. In another example, the pre-defined list of separation elements may define a priority relationship between the component tasks they separate. In this example, a preposition separation element such as “to” may have a defined rule dictating that the second component task of the two component tasks separated by the “to” is higher than the first component task in the pipeline.

Alternatively, the pipeline may be determined by prompting a large language model to determine a pipeline for execution of component tasks. In this case, a prompt may be generated that includes the user query, the detected component tasks, and a request to determine a logical dependency between the detected component tasks. The prompt may also include examples of pre-determined or prior user queries, their component tasks, and the logical dependencies between the component tasks. After receiving a result from the large language model, the logical dependencies may be used to determine a pipeline for execution of the component tasks based on the logical dependencies returned by the large language model.

The pipeline may also be determined by a combination of the above methods. For example, the pipeline may be determined by first parsing the user query applying a set of pre-determined rules. The result of those rules may be used to label the component tasks with a most likely pipeline order. A prompt may then be generated including the user query, the component tasks, the most likely pipeline order labels, a request to determine an execution order for the component tasks based on logical dependencies of the component tasks, and an added explanation of the most likely pipeline order labels.

### Computer System Architecture

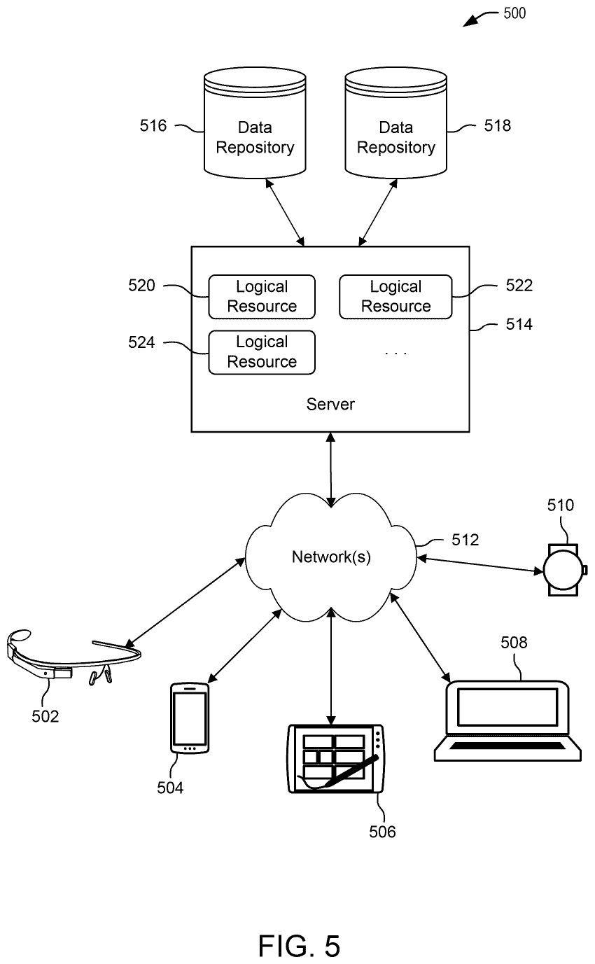

FIG. 5 depicts a simplified diagram of a distributed system 500 for implementing an embodiment. In the illustrated embodiment, distributed system 500 includes one or more client computing devices 502, 504, 506, 508, and/or 510 coupled to a server 514 via one or more communication networks 512. Clients computing devices 502, 504, 506, 508, and/or 510 may be configured to execute one or more applications.

In various aspects, server 514 may be adapted to run one or more services or software applications that enable techniques for processing user queries.

In certain aspects, server 514 may also provide other services or software applications that can include non-virtual and virtual environments. In some aspects, these services may be offered as web-based or cloud services, such as under a Software as a Service (Saas) model to the users of client computing devices 502, 504, 506, 508, and/or 510. Users operating client computing devices 502, 504, 506, 508, and/or 510 may in turn utilize one or more client applications to interact with server 514 to utilize the services provided by these components.

In the configuration depicted in FIG. 5, server 514 may include one or more components 520, 522 and 524 that implement the functions performed by server 514. These components may include software components that may be executed by one or more processors, hardware components, or combinations thereof. It should be appreciated that various different system configurations are possible, which may be different from distributed system 500. The embodiment shown in FIG. 5 is thus one example of a distributed system for implementing an embodiment system and is not intended to be limiting.

Users may use client computing devices 502, 504, 506, 508, and/or 510 for techniques for user query processing in accordance with the teachings of this disclosure. A client device may provide an interface that enables a user of the client device to interact with the client device. The client device may also output information to the user via this interface. Although FIG. 5 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google Assistant, Microsoft® Cortana®, Apple® Siri®, and others may be implemented on devices with a microphone and/or camera to receive user or environmental inputs, as well as a speaker and/or display to respond to the inputs. Wearable devices may include Apple Watch, Samsung Galaxy Watch, Meta Quest®, Ray-Ban Meta® smart glasses, Snap® Spectacles, and other devices. Gaming systems may include various handheld gaming devices, Internet-enabled gaming devices (e.g., a Microsoft XboxR gaming console with or without a KinectR gesture input device, Sony PlayStationR system, Nintendo Switch™, and other devices), and the like. The client devices may be capable of executing various different applications such as various Internet-related apps, communication applications (e.g., e-mail applications, short message service (SMS) applications) and may use various communication protocols.

Network(s) 512 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk, and the like. Merely by way of example, network(s) 512 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth™, and/or any other wireless protocol), and/or any combination of these and/or other networks.

Server 514 may be composed of one or more general purpose computers, specialized server computers (including, by way of example, PC (personal computer) servers, UNIX® servers, LINIX® servers, mid-range servers, mainframe computers, rack-mounted servers, etc.), server farms, server clusters, a Real Application Cluster (RAC), database servers, or any other appropriate arrangement and/or combination. Server 514 can include one or more virtual machines running virtual operating systems, or other computing architectures involving virtualization such as one or more flexible pools of logical storage devices that can be virtualized to maintain virtual storage devices for the server. In various aspects, server 514 may be adapted to run one or more services or software applications that provide the functionality described in the foregoing disclosure.

The computing systems in server 514 may run one or more operating systems including any of those discussed above, as well as any commercially available server operating system. Server 514 may also run any of a variety of additional server applications and/or mid-tier applications, including HTTP (hypertext transport protocol) servers, FTP (file transfer protocol) servers, CGI (common gateway interface) servers, JAVAR servers, database servers, and the like. Exemplary database servers include without limitation those commercially available from Oracle®, Microsoft®, SAP®, Amazon®, Sybase®, IBM (International Business Machines), and the like.

In some implementations, server 514 may include one or more applications to analyze and consolidate data feeds and/or event updates received from users of client computing devices 502, 504, 506, 508, and/or 510. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 514 may also include one or more applications to display the data feeds and/or real-time events via one or more display devices of client computing devices 502, 504, 506, 508, and/or 510.

Distributed system 500 may also include one or more data repositories 516, 518. These data repositories may be used to store data and other information in certain aspects. For example, one or more of the data repositories 516, 518 may be used to store information for techniques for user query processing. Data repositories 516, 518 may reside in a variety of locations. For example, a data repository used by server 514 may be local to server 514 or may be remote from server 514 and in communication with server 514 via a network-based or dedicated connection. Data repositories 516, 518 may be of different types. In certain aspects, a data repository used by server 514 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 516, 518 may also be used by applications to store application data. The data repositories used by applications may be of different types such as, for example, a key-value store repository, an object store repository, or a general storage repository supported by a file system.

In one embodiment, server 514 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

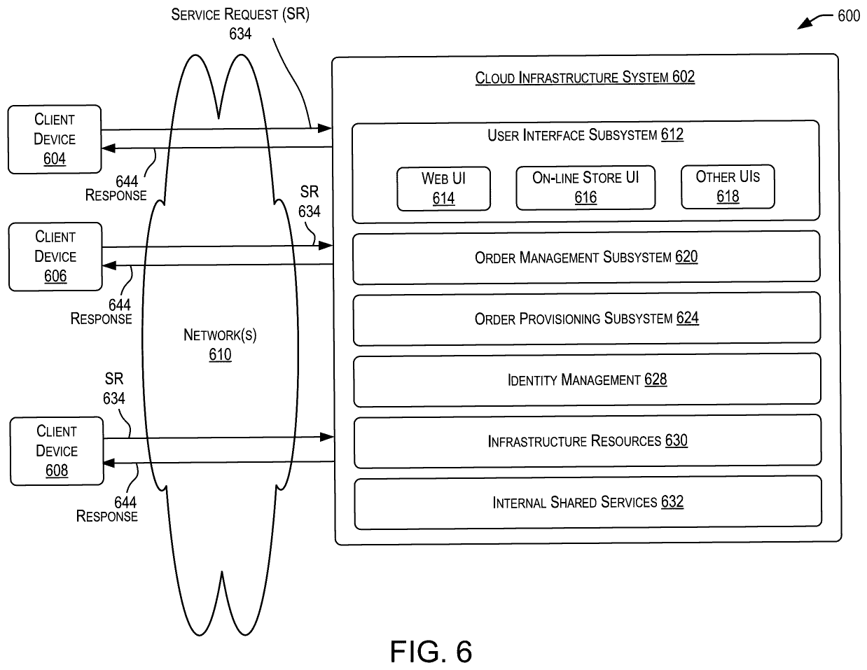

FIG. 6 is a simplified block diagram of a cloud-based system environment in which user queries are processed, in accordance with certain aspects. In the embodiment depicted in FIG. 6, cloud infrastructure system 602 may provide one or more cloud services that may be requested by users using one or more client computing devices 604, 606, and 608. Cloud infrastructure system 602 may comprise one or more computers and/or servers that may include those described above for server 514. The computers in cloud infrastructure system 602 may be organized as general purpose computers, specialized server computers, server farms, server clusters, or any other appropriate arrangement and/or combination.

Network(s) 610 may facilitate communication and exchange of data between clients 604, 606, and 608 and cloud infrastructure system 602. Network(s) 610 may include one or more networks. The networks may be of the same or different types. Network(s) 610 may support one or more communication protocols, including wired and/or wireless protocols, for facilitating the communications.

The embodiment depicted in FIG. 6 is only one example of a cloud infrastructure system and is not intended to be limiting. It should be appreciated that, in some other aspects, cloud infrastructure system 602 may have more or fewer components than those depicted in FIG. 6, may combine two or more components, or may have a different configuration or arrangement of components. For example, although FIG. 6 depicts three client computing devices, any number of client computing devices may be supported in alternative aspects.

The term cloud service is generally used to refer to a service that is made available to users on demand and via a communication network such as the Internet by systems (e.g., cloud infrastructure system 602) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 610 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 602 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 602 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 602. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 602. Cloud infrastructure system 602 then performs processing to provide the services requested in the tenant's subscription order. Cloud infrastructure system 602 may be configured to provide one or even multiple cloud services.

Cloud infrastructure system 602 may provide the cloud services via different deployment models. In a public cloud model, cloud infrastructure system 602 may be owned by a third party cloud services provider and the cloud services are offered to any general public tenant, where the tenant can be an individual or an enterprise. In certain other aspects, under a private cloud model, cloud infrastructure system 602 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 602 and the services provided may be shared by several organizations in a related community. Various other models such as hybrids of the above mentioned models may also be used.

Client computing devices 604, 606, and 608 may be of different types (such as devices 502, 504, 506, and 508 depicted in FIG. 5) and may be capable of operating one or more client applications. A user may use a client device to interact with cloud infrastructure system 602, such as to request a service provided by cloud infrastructure system 602.

In some aspects, the processing performed by cloud infrastructure system 602 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 602 for determining the intent of an utterance. The data used for this analysis may include structured data (e.g., data stored in a database or structured according to a structured model) and/or unstructured data (e.g., data blobs (binary large objects)).

As depicted in the embodiment in FIG. 6, cloud infrastructure system 602 may include infrastructure resources 630 that are utilized for facilitating the provision of various cloud services offered by cloud infrastructure system 602. Infrastructure resources 630 may include, for example, processing resources, storage or memory resources, networking resources, and the like.

In certain aspects, to facilitate efficient provisioning of these resources for supporting the various cloud services provided by cloud infrastructure system 602 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 602 may itself internally use services 632 that are shared by different components of cloud infrastructure system 602 and which facilitate the provisioning of services by cloud infrastructure system 602. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 602 may comprise multiple subsystems. These subsystems may be implemented in software, or hardware, or combinations thereof. As depicted in FIG. 6, the subsystems may include a user interface subsystem 612 that enables users of cloud infrastructure system 602 to interact with cloud infrastructure system 602. User interface subsystem 612 may include various different interfaces such as a web interface 614, an online store interface 616 where cloud services provided by cloud infrastructure system 602 are advertised and are purchasable by a consumer, and other interfaces 618. For example, a tenant may, using a client device, request (service request 634) one or more services provided by cloud infrastructure system 602 using one or more of interfaces 614, 616, and 618. For example, a tenant may access the online store, browse cloud services offered by cloud infrastructure system 602, and place a subscription order for one or more services offered by cloud infrastructure system 602 that the tenant wishes to subscribe to. The service request may include information identifying the tenant and one or more services that the tenant desires to subscribe to. For example, a tenant may place a subscription order for a chatbot related service offered by cloud infrastructure system 602. As part of the order, the client may provide information identifying the input (e.g. utterances).

In certain aspects, such as the embodiment depicted in FIG. 6, cloud infrastructure system 602 may comprise an order management subsystem (OMS) 620 that is configured to process the new order. As part of this processing, OMS 620 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 620 may then invoke the order provisioning subsystem (OPS) 624 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 624 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 602 may send a response or notification 644 to the requesting tenant to indicate when the requested service is now ready for use. In some instances, information (e.g., a link) may be sent to the tenant that enables the tenant to start using and availing the benefits of the requested services.

Cloud infrastructure system 602 may provide services to multiple tenants. For each tenant, cloud infrastructure system 602 is responsible for managing information related to one or more subscription orders received from the tenant, maintaining tenant data related to the orders, and providing the requested services to the tenant or clients of the tenant. Cloud infrastructure system 602 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 602 may provide services to multiple tenants in parallel. Cloud infrastructure system 602 may store information for these tenants, including possibly proprietary information. In certain aspects, cloud infrastructure system 602 comprises an identity management subsystem (IMS) 628 that is configured to manage tenant's information and provide the separation of the managed information such that information related to one tenant is not accessible by another tenant. IMS 628 may be configured to provide various security-related services such as identity services, such as information access management, authentication and authorization services, services for managing tenant identities and roles and related capabilities, and the like.

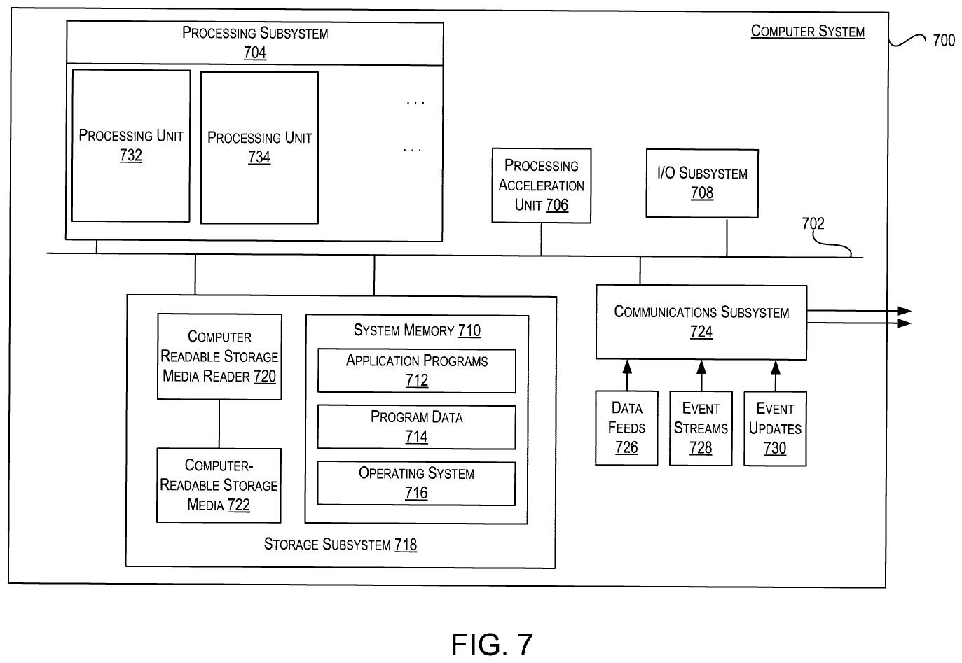

FIG. 7 illustrates an exemplary computer system 700 that may be used to implement certain aspects. As shown in FIG. 7, computer system 700 includes various subsystems including a processing subsystem 704 that communicates with a number of other subsystems via a bus subsystem 702. These other subsystems may include a processing acceleration unit 706, an I/O subsystem 708, a storage subsystem 718, and a communications subsystem 724. Storage subsystem 718 may include non-transitory computer-readable storage media including storage media 722 and a system memory 710.

Bus subsystem 702 provides a mechanism for letting the various components and subsystems of computer system 700 communicate with each other as intended. Although bus subsystem 702 is shown schematically as a single bus, alternative aspects of the bus subsystem may utilize multiple buses. Bus subsystem 702 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 704 controls the operation of computer system 700 and may comprise one or more processors, application specific integrated circuits (ASICs), or field programmable gate arrays (FPGAs). The processors may be single core or multicore processors. The processing resources of computer system 700 can be organized into one or more processing units 732, 734, etc. A processing unit may include one or more processors, one or more cores from the same or different processors, a combination of cores and processors, or other combinations of cores and processors. In some aspects, processing subsystem 704 can include one or more special purpose co-processors such as graphics processors, digital signal processors (DSPs), or the like. In some aspects, some or all of the processing units of processing subsystem 704 can be implemented using customized circuits, such as application specific integrated circuits (ASICs), or field programmable gate arrays (FPGAs).

In some aspects, the processing units in processing subsystem 704 can execute instructions stored in system memory 710 or on computer readable storage media 722. In various aspects, the processing units can execute a variety of programs or code instructions and can maintain multiple concurrently executing programs or processes. At any given time, some or all of the program code to be executed can be resident in system memory 710 and/or on computer-readable storage media 722 including potentially on one or more storage devices. Through suitable programming, processing subsystem 704 can provide various functionalities described above. In instances where computer system 700 is executing one or more virtual machines, one or more processing units may be allocated to each virtual machine.

In certain aspects, a processing acceleration unit 706 may optionally be provided for performing customized processing or for off-loading some of the processing performed by processing subsystem 704 so as to accelerate the overall processing performed by computer system 700.

I/O subsystem 708 may include devices and mechanisms for inputting information to computer system 700 and/or for outputting information from or via computer system 700. In general, use of the term input device is intended to include all possible types of devices and mechanisms for inputting information to computer system 700. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Questx controller, Microsoft KinectR motion sensor, the Microsoft Xbox 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri navigator or Amazon AlexaR) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 700 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 718 provides a repository or data store for storing information and data that is used by computer system 700. Storage subsystem 718 provides a tangible non-transitory computer-readable storage medium for storing the basic programming and data constructs that provide the functionality of some aspects. Storage subsystem 718 may store software (e.g., programs, code modules, instructions) that when executed by processing subsystem 704 provides the functionality described above. The software may be executed by one or more processing units of processing subsystem 704. Storage subsystem 718 may also provide a repository for storing data used in accordance with the teachings of this disclosure.

Storage subsystem 718 may include one or more non-transitory memory devices, including volatile and non-volatile memory devices. As shown in FIG. 7, storage subsystem 718 includes a system memory 710 and a computer-readable storage media 722. System memory 710 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 700, such as during start-up, may typically be stored in the ROM. The RAM typically contains data and/or program modules that are presently being operated and executed by processing subsystem 704. In some implementations, system memory 710 may include multiple different types of memory, such as static random access memory (SRAM), dynamic random access memory (DRAM), and the like.

By way of example, and not limitation, as depicted in FIG. 7, system memory 710 may load application programs 712 that are being executed, which may include various applications such as Web browsers, mid-tier applications, relational database management systems (RDBMS), etc., program data 714, and an operating system 716. By way of example, operating system 716 may include various versions of Microsoft Windows®, Apple Macintosh®, and/or Linux operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows Phone, Android® OS, and others.

Computer-readable storage media 722 may store programming and data constructs that provide the functionality of some aspects. Computer-readable media 722 may provide storage of computer-readable instructions, data structures, program modules, and other data for computer system 700. Software (programs, code modules, instructions) that, when executed by processing subsystem 704 provides the functionality described above, may be stored in storage subsystem 718. By way of example, computer-readable storage media 722 may include non-volatile memory such as a hard disk drive, a magnetic disk drive, an optical disk drive such as a CD ROM, digital video disc (DVD), a Blu-Ray disk, or other optical media. Computer-readable storage media 722 may include, but is not limited to, ZipR drives, flash memory cards, universal serial bus (USB) flash drives, secure digital (SD) cards, DVD disks, digital video tape, and the like. Computer-readable storage media 722 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 718 may also include a computer-readable storage media reader 720 that can further be connected to computer-readable storage media 722. Reader 720 may receive and be configured to read data from a memory device such as a disk, a flash drive, etc.

In certain aspects, computer system 700 may support virtualization technologies, including but not limited to virtualization of processing and memory resources. For example, computer system 700 may provide support for executing one or more virtual machines. In certain aspects, computer system 700 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 700. Accordingly, multiple operating systems may potentially be run concurrently by computer system 700.

Communications subsystem 724 provides an interface to other computer systems and networks. Communications subsystem 724 serves as an interface for receiving data from and transmitting data to other systems from computer system 700. For example, communications subsystem 724 may enable computer system 700 to establish a communication channel to one or more client devices via the Internet for receiving and sending information from and to the client devices. For example, the communications subsystem may be used to transmit a response to a user regarding the inquiry for a chatbot.

Communications subsystem 724 may support both wired and/or wireless communication protocols. For example, in certain aspects, communications subsystem 724 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 724 can provide wired network connectivity (e.g., Ethernet) in addition to or instead of a wireless interface.

Communications subsystem 724 can receive and transmit data in various forms. For example, in some aspects, in addition to other forms, communications subsystem 724 may receive input communications in the form of structured and/or unstructured data feeds 726, event streams 728, event updates 730, and the like. For example, communications subsystem 724 may be configured to receive (or send) data feeds 726 in real-time from users of social media networks and/or other communication services such as Twitter® feeds, Facebook updates, web feeds such as Rich Site Summary (RSS) feeds, and/or real-time updates from one or more third party information sources.

In certain aspects, communications subsystem 724 may be configured to receive data in the form of continuous data streams, which may include event streams 728 of real-time events and/or event updates 730, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 724 may also be configured to communicate data from computer system 700 to other computer systems or networks. The data may be communicated in various different forms such as structured and/or unstructured data feeds 726, event streams 728, event updates 730, and the like to one or more databases that may be in communication with one or more streaming data source computers coupled to computer system 700.

Computer system 700 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 700 depicted in FIG. 7 is intended only as a specific example. Many other configurations having more or fewer components than the system depicted in FIG. 7 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
receiving a request comprising a natural language item, the natural language item comprising a first natural language component and a second natural language component;
determining a logical dependency of the second natural language component on the first natural language component;
determining a first category for the first natural language component;
determining a second category for the second natural language component;
selecting, from a plurality of different candidate natural language processing services, a first natural language processing service associated with the first category, wherein the first natural language processing service supports one or more first applications;
selecting, from a plurality of different candidate natural language processing services, a second natural language processing service associated with the second category, wherein the second natural language processing service supports one or more second applications;
sending the first natural language component to the first natural language processing service;
receiving a first response from the first natural language processing service, wherein the first response comprises one or more values responsive to the first natural language component;
based at least in part on the second natural language component and the one or more values responsive to the first natural language component, generating a modified second natural language component;
sending the modified second natural language component to the second natural language processing service;
receiving a second response from the second natural language processing service, wherein the second response comprises an option to trigger one or more actions in at least one second application of the one or more second applications responsive to the modified second natural language component;
triggering the one or more actions by sending one or more commands to the at least one second application.

2. The computer-implemented method of claim 1, wherein the method further comprises:
causing the display to a user the option to trigger the one or more actions in the at least one second application, and wherein the triggering the one or more actions is in response to receiving a confirmation from the user.

3. The computer-implemented method of claim 1, wherein the method further comprises:
accessing metadata that describes one or more candidate operations for the one or more first applications;
generating a prompt including at least part of the metadata and the first response;
prompting a large language model with the prompt to validate that the first response is a valid response for the first category.

4. The computer-implemented method of claim 1, wherein the method further comprises:
prompting a large language model with the natural language item to detect the first natural language component and the second natural language component from the natural language item; and
receiving the first natural language component and the second natural language component from the large language model.

5. The computer-implemented method of claim 1, wherein the method further comprises:
accessing one or more stored rules to detect separation between natural language components;
determining the first natural language component and the second natural language component from the natural language item based at least in part on a particular detected separation between the first natural language component and the second natural language component.

6. The computer-implemented method of claim 1, wherein the determining the first category for the first natural language component comprises:
generating a prompt, wherein the prompt comprises the first natural language component
and a plurality of candidate categories; and
prompting a large language model with the prompt to determine a particular category of the plurality of candidate categories for the first natural language component; and
based at least in part on a result of the prompting, determining the first category for the first natural language component.

7. The computer-implemented method of claim 1, wherein the first natural language processing service comprises a first machine learning model,
wherein the first machine learning model is trained based at least in part on first metadata that describes one or more first candidate operations for the one or more first applications,
wherein the second natural language processing service comprises a second machine learning model, and
wherein the second machine learning model is trained based at least in part on second metadata that describes one or more second candidate operations for the one or more second applications.

8. The computer-implemented method of claim 1, wherein the method further comprises:
generating a prompt comprising the one or more commands;
prompting a large language model to generate a natural language description of the one or more commands; and
determining the one or more actions based at least in part on a response from the prompting.

9. The computer-implemented method of claim 1, wherein the method further comprises:
causing display of the one or more actions to a user;
receiving an input from the user indicating against the one or more actions; and
to reverse the one or more actions, sending to the at least one second application another one or more commands associated with the one or more commands.

10. The computer-implemented method of claim 1, wherein the method further comprises:
causing navigation to a particular interface in the at least one second application, wherein the one or more actions partially accomplish the request defined by the natural language item, and wherein the particular interface comprises one or more options to complete the request defined by the natural language item.

11. A computer-program product comprising one or more non-transitory machine-readable storage media, including stored instructions configured to cause a computing system to perform a set of actions including:
receiving a request comprising a natural language item, the natural language item comprising a first natural language component and a second natural language component;
determining a logical dependency of the second natural language component on the first natural language component;
determining a first category for the first natural language component;
determining a second category for the second natural language component;
selecting, from a plurality of different candidate natural language processing services, a first natural language processing service associated with the first category, wherein the first natural language processing service supports one or more first applications;
selecting, from a plurality of different candidate natural language processing services, a second natural language processing service associated with the second category, wherein the second natural language processing service supports one or more second applications;
sending the first natural language component to the first natural language processing service;
receiving a first response from the first natural language processing service, wherein the first response comprises one or more values responsive to the first natural language component;
based at least in part on the second natural language component and the one or more values responsive to the first natural language component, generating a modified second natural language component;
sending the modified second natural language component to the second natural language processing service;
receiving a second response from the second natural language processing service, wherein the second response comprises an option to trigger one or more actions in at least one second application of the one or more second applications responsive to the modified second natural language component;
triggering the one or more actions by sending one or more commands to the at least one second application.

12. The computer-program product of claim 11, wherein the set of actions further includes:
causing the display to a user the option to trigger the one or more actions in the at least one second application, and wherein the triggering the one or more actions is in response to receiving a confirmation from the user.

13. The computer-program product of claim 11, wherein the set of actions further includes:
accessing metadata that describes one or more candidate operations for the one or more first applications;
generating a prompt including at least part of the metadata and the first response;
prompting a large language model with the prompt to validate that the first response is a valid response for the first category.

14. The computer-program product of claim 11, wherein the set of actions further includes:
prompting a large language model with the natural language item to detect the first natural language component and the second natural language component from the natural language item; and
receiving the first natural language component and the second natural language component from the large language model.

15. The computer-program product of claim 11, wherein the set of actions further includes:
accessing one or more stored rules to detect separation between natural language components;
determining the first natural language component and the second natural language component from the natural language item based at least in part on a particular detected separation between the first natural language component and the second natural language component.

16. A system comprising:
one or more processors;
one or more non-transitory computer-readable media storing instructions, which, when executed by the system, cause the system to perform a set of actions including:
receiving a request comprising a natural language item, the natural language item comprising a first natural language component and a second natural language component;
determining a logical dependency of the second natural language component on the first natural language component;
determining a first category for the first natural language component;
determining a second category for the second natural language component;
selecting, from a plurality of different candidate natural language processing services, a first natural language processing service associated with the first category, wherein the first natural language processing service supports one or more first applications;
selecting, from a plurality of different candidate natural language processing services, a second natural language processing service associated with the second category, wherein the second natural language processing service supports one or more second applications;
sending the first natural language component to the first natural language processing service;
receiving a first response from the first natural language processing service, wherein the first response comprises one or more values responsive to the first natural language component;
based at least in part on the second natural language component and the one or more values responsive to the first natural language component, generating a modified second natural language component;
sending the modified second natural language component to the second natural language processing service;
receiving a second response from the second natural language processing service, wherein the second response comprises an option to trigger one or more actions in at least one second application of the one or more second applications responsive to the modified second natural language component;
triggering the one or more actions by sending one or more commands to the at least one second application.

17. The system of claim 16, wherein the set of actions further includes:
causing the display to a user the option to trigger the one or more actions in the at least one second application, and wherein the triggering the one or more actions is in response to receiving a confirmation from the user.

18. The system of claim 16, wherein the set of actions further includes:
accessing metadata that describes one or more candidate operations for the one or more first applications;
generating a prompt including at least part of the metadata and the first response;
prompting a large language model with the prompt to validate that the first response is a valid response for the first category.

19. The system of claim 16, wherein the set of actions further includes:
prompting a large language model with the natural language item to detect the first natural language component and the second natural language component from the natural language item; and
receiving the first natural language component and the second natural language component from the large language model.

20. The system of claim 16, wherein the set of actions further includes:
accessing one or more stored rules to detect separation between natural language components;
determining the first natural language component and the second natural language component from the natural language item based at least in part on a particular detected separation between the first natural language component and the second natural language component.
